(19) United States
(12) Patent Application Publication
(10) Pub. No.: US 2019/0277078 A1
(43) Pub. Date: Sep. 12, 2019

(54) SYSTEM FOR GARAGE DOOR ANTI-DESPOOLING AND SELF POWERING

(71) Applicant: MAGNA CLOSURES INC., Newmarket (CA)

(72) Inventors: Samuel R. BARUCO, Aurora (CA); Faraz OSSAREH, Newmarket (CA); Bill SHAW, Richmond Hill (CA)

(21) Appl. No.: 16/297,862

(22) Filed: Mar. 11, 2019

Related U.S. Application Data
(60) Provisional application No. 62/641,559, filed on Mar. 12, 2018.

(51) Int. Cl. E05F 15/686

(52) U.S. Cl. CPC E05F 15/686; E05Y 2900/106

(57) ABSTRACT

A powered garage door opener in a door assembly including a shaft coupled to a pulley with a cable to lift a garage door with an electric motor coupled to the shaft, includes a braking circuit for regulating the speed of the shaft when it is not actively powered by the electric motor. The braking circuit includes a first switch to connect a first braking resistor across the electric motor to provide a first braking force. A braking controller monitors the speed of the garage door and selectively commands a second switch to close and to connect a second braking resistor and to thereby cause the electric motor to apply a second braking force significantly greater than the first braking force. A rectifier is connected across the first braking resistor to provide power to a motor drive controller using the induced voltage from the turning electric motor.

### CROSS-REFERENCE TO RELATED APPLICATIONS

This utility application claims the benefit of U.S. Provisional Application No. 62/641,559, filed Mar. 12, 2018. The entire disclosure of the above application is incorporated herein by reference.

### FIELD

The present disclosure relates generally to a powered garage door opener for powering a garage door between and opened and closed positions. More particularly, it relates to an apparatus for using an electric motor in a powered garage door opener to apply a braking force in opposition to an external force moving the garage door opener.

### BACKGROUND

A garage door assembly includes a garage door attached to a rotating shaft via a pulley and cable. A garage door opener, including an electric motor, is used to drive the garage door between and opened and closed positions. It is also possible to backdrive the garage door opener, for example, by manually moving the garage door. This backdriving can accelerate the garage door opener to speeds that are in excess of a safe operating range of the electric motor. This backdriving can also cause the garage door to move faster than the drum is able to turn, which can cause the cable to loose tension, allowing it to move off of the drum or have an incorrect orientation on the drum, causing the garage door assembly to be inoperable.

When there is utility power to the garage door opener, software and hardware can monitor the speed of the unit but when there is no external power, such as with the unit unplugged or during a power failure, existing garage door openers are unable to know the (relative) speed of the door or to control the speed of the door or the electric motor. When there is no external power, systems of the prior art are unable control the speed of the door or the electric motor.

No solution is known from the prior art which allows a garage door opener to controllably apply a braking force, and without external utility power.

### SUMMARY

A garage door opener includes an electric motor coupled to a garage door via mechanical linkage for raising and lowering the garage door. The garage door opener also includes a motor drive controller configured to provide electrical power to the electric motor to cause the electric motor to apply a driving torque to the mechanical linkage for raising or lowering the garage door. The electric motor generates an induced voltage in response to application of an external force to the mechanical linkage. The garage door opener includes a first switch which is operable in a soft braking mode to conduct electrical current from the electric motor through a load to cause the electric motor to apply a first braking force in opposition to the external force.

A method for operating a garage door opener is also provided. The method includes the steps of actuating an electric motor of the garage door opener by an external force; generating an induced voltage by the electric motor; conducting electrical current through a first switch between the electric motor and a load with the first switch in a soft braking mode; and dissipating power by the load to cause the electric motor to apply a first braking force in opposition to the external force.

In accordance with another aspect, there is provided a garage door opener including an electric motor coupled to a garage door via a mechanical linkage for raising and lowering the garage door, a motor drive controller configured to provide electrical power to the electric motor to cause the electric motor to apply a driving torque to the mechanical linkage for raising or lowering the garage door, the electric motor capable of generating an induced voltage in response to application of an external force to the mechanical linkage, the induced voltage to be supplied and used to operate the motor drive controller.

### BRIEF DESCRIPTION OF THE DRAWINGS

Further details, features and advantages of designs of the invention result from the following description of embodiment examples in reference to the associated drawings.

FIG. 1 is a perspective view of a powered garage door opener operatively coupled to a shaft of a garage door assembly;

FIG. 2 is a side view of the powered garage door opener;

FIG. 3 is an electrical schematic of a braking circuit for a powered garage door opener;

FIG. 4 is an electrical schematic of a motor control circuit with an electric motor in a non-energized and non-driving condition;

FIG. 5 is an electrical schematic showing electrical current flow in the motor control circuit of FIG. 4 driving the electric motor in a first direction;

FIG. 6 is an electrical schematic showing electrical current flow in the motor control circuit of FIG. 4 driving the electric motor in a second direction;

FIG. 7 is an electrical schematic showing electrical current flow in the motor control circuit of FIG. 4 operating in a soft braking mode;

FIG. 8 is an electrical schematic showing electrical current flow in the motor control circuit of FIG. 4 operating in a hard braking mode;

FIG. 9A is a flow chart of method steps for operating a braking circuit of a powered garage door opener;

FIG. 9B is a continuation of the flow chart of FIG. 9A;

FIGS. 9C-9F are flow charts of method steps for operating a braking circuit of a powered garage door opener, in accordance with other illustrative embodiments;

FIG. 10 is a state diagram illustrating the various operating modes of an electronic control module of the garage door opener of FIG. 1, in accordance with an illustrative embodiment; and

FIGS. 11A to 11C are flowcharts of operations performed by an electronic control module of the garage door opener of FIG. 1, in accordance with illustrative embodiments.

### DETAILED DESCRIPTION

Example embodiments of a powered, side-mounted garage door opener are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

Recurring features are marked with identical reference numerals in the figures, in which a system for braking and self-powering of a powered garage door opener 10 in a door assembly 13 is disclosed.

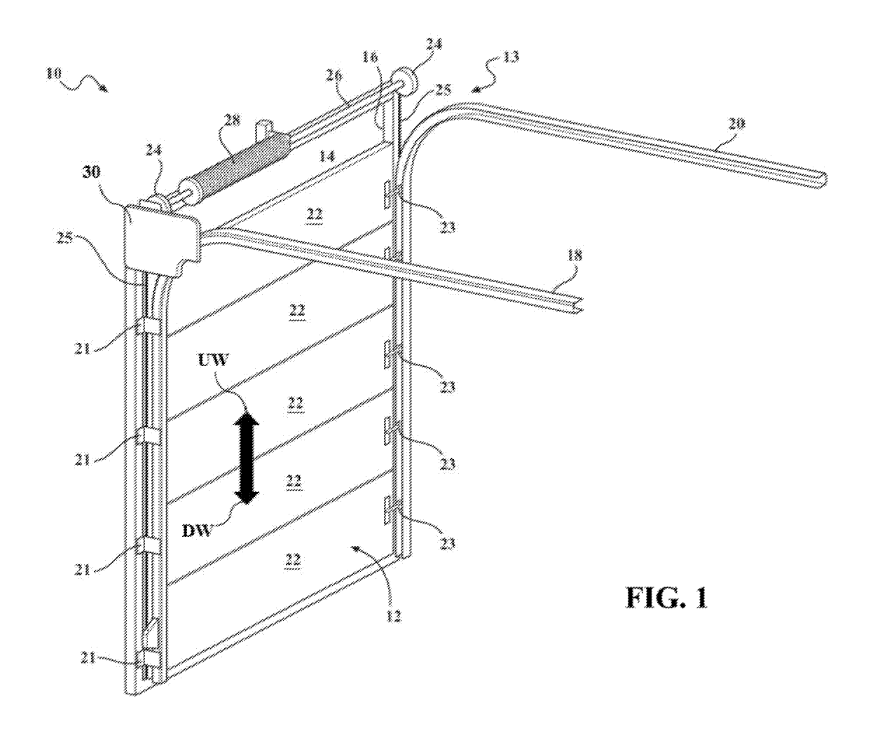

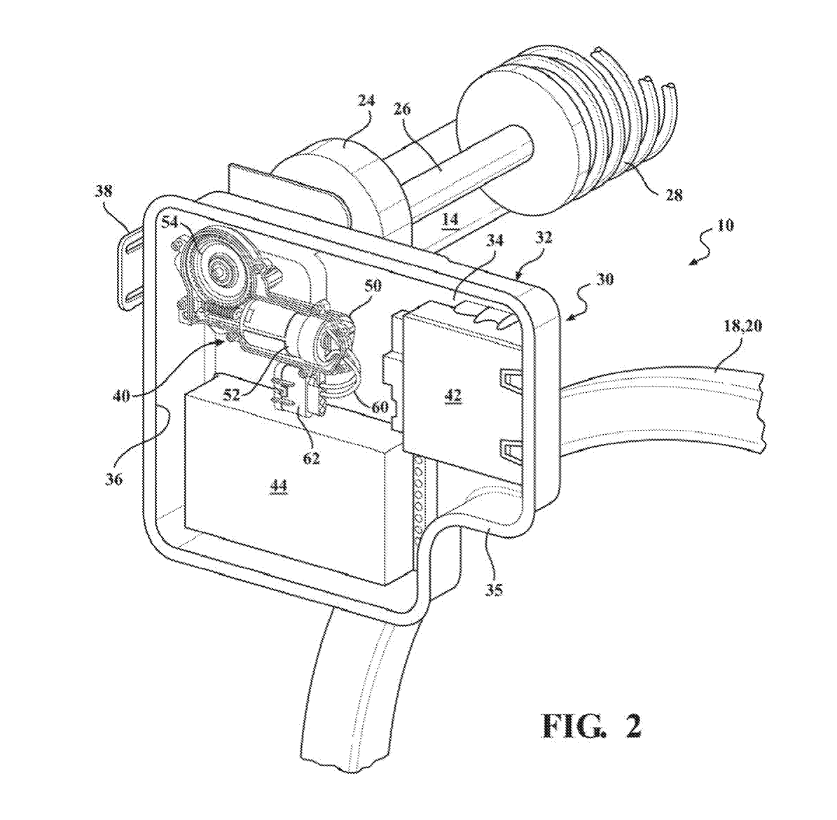

Referring initially to FIGS. 1-2, wherein like numerals indicate like or corresponding parts throughout the several views, a powered garage door opener according to an exemplary embodiment is generally shown at 10 and which is operable for opening and closing a garage door generally shown at 12. An upright planar garage wall 14 defines a garage door opening 16 which is opened and closed by garage door 12.

Referring to FIG. 1, garage door 12 is part of a garage door assembly 13 which also includes a pair of parallel and spaced apart guide tracks 18, 20 fixedly secured by brackets 21 to garage wall 14 along opposing sides of opening 16. Garage door 12 includes a plurality of garage door panels 22 that are pivotally interconnected along their longitudinal sides by a plurality of pivot brackets and are retained within guide tracks 18, 20 along their lateral sides by a plurality of roller wheels 23. Garage door assembly 13 also includes an elongated shaft 26 that is rotatably coupled to garage wall 14 above opening 16, with each distal end supporting a pulley 24. A cable 25 is wound around each pulley 24 and includes a first end fixed to pulley 24 and a second end fixed to the bottom door panel 22 for lifting the interconnected door panels 22 along guide tracks 18, 20 upon rotation of shaft 26 for moving garage door 12 between a closed position covering opening 16 and an open position spaced above opening 16. A torsion spring 28 is wound about shaft 26 for assisting rotation of shaft 26 and raising garage door 12 to the open position. The pre-loaded torque on torsion spring 28 may be adjusted at the time of installation to adjust the assist level in raising garage door 12 or stopping door movement at all positions between the open and closed positions as desired.

Powered garage door opener 10 is fixedly mounted to garage wall 14 adjacent one side portion of opening 16 and is operatively coupled to one end of shaft 26 for rotating shaft 26 and facilitating actuation of garage door 12 between the open and closed positions. Thus, powered garage door opener 10 can also be referred to as a “side-mounted” or “shaft-mounted” garage door opener. Other configurations of powered garage door opener 10 are also possible for effectuating movement of the garage door 12, for example in another embodiment the powered garage door opener 10 acts on the garage door 12 via movement of a bracket moved by a chain or belt driven by a motor and as guided in a track mounted to a ceiling, where the spooling and biasing assembly acts separately on the garage door 12, for example as described in U.S. Pat. No. 4,597,428, entitled “Two Drum Cable Drive Garage Door Opener” the entire contents of which are incorporated by reference herein.

Referring to FIG. 2, powered garage door opener 10 includes an outer housing 30 made of plastic or metal. Outer housing 30 includes a bin 32 forming a cavity extending from a back plate 34 and a peripheral flange 35 to define a front opening 36, and a cover (not shown) for covering the front opening 36 of bin 32. An L-shaped bracket 38 is attached to the outer housing 30 for securing the unit to garage wall 14.

Referring to FIG. 2, garage door opener 10 is shown mounted to garage wall 14 adjacent garage door assembly 13 and operatively coupled to shaft 26. The cover of the outer housing 30 has been removed to disclose the cavity within bin 32. Bin 32 houses an electric motor and reduction gears 54 operatively coupled to shaft 26, an electronic control module 42 electrically connected to the electric motor 52, and a power supply 56 electrically connected to electronic control module 42 and electric motor 52 for providing power thereto. More specifically, power supply 56 is a 12V DC output power supply which may be powered by a utility power supply, such as standard household AC outlet on garage wall 14. Alternatively, the garage door opener 10 may be powered from the utility power supply via a hardwired connection, which may be fed, for example, by a circuit breaker panel.

Electronic control module 42 may be software controlled to actuate the electric motor 52 for driving the shaft 26 to move the interconnected garage door panels 22 between the open and closed positions. Electronic control module 42 illustratively includes a motor drive controller 43, for example provided with a microcontroller, microprocessor or analogous computing module 43a mounted on a printed circuit board (not shown), and coupled to the electric motor 52 of the garage door opener 10, to control its operation. The control unit 43 has an embedded memory 43b, for example a non-volatile random access memory, coupled to the computing module 43a, storing suitable programs and computer instructions (for example in the form of a firmware). It is recognized that the control unit 43 may alternatively comprise a logical circuit of discrete components to carry out the functions of the computing module 43a and memory 43b.

Electronic control module 42 may be controlled remotely by a wireless vehicle controller, a wired or wireless controller mounted to garage wall 14, a wireless key fob-type controller, a mobile phone/smart phone application, or any other type of transmitter for providing a control signal to module 42. When more than one powered garage door opener 10 is installed on the same garage door shaft 26, the respective electronic control modules 42 may be encoded to simultaneously respond to the same control signal.

Still referring to FIG. 2, electric motor and geartrain assembly 40 comprises a sealed motor-geartrain housing 50 which is fixedly mounted within the cavity of bin 32 of outer housing 30. An electrical wiring harness 60 and a coupling 62 extend from one end of electric motor 52 and through housing 50 for electrical connection to electronic control module 42 and power supply 56.

The garage door opener 10 includes an electric motor 52 coupled to the garage door 12 via a mechanical linkage for raising and lowering the garage door 12. The mechanical linkage may include one or more pulleys 24 and cables 25, such as in the embodiment shown in FIG. 1, for assisting the electric motor 52 with movement of the garage door 12. The mechanical linkage may include other mechanisms, such as a chain drive, a belt drive, or a worm gear drive. Alternatively or additionally, the mechanical linkage may include one or more reduction gears, such as the ones shown in FIG. 2.

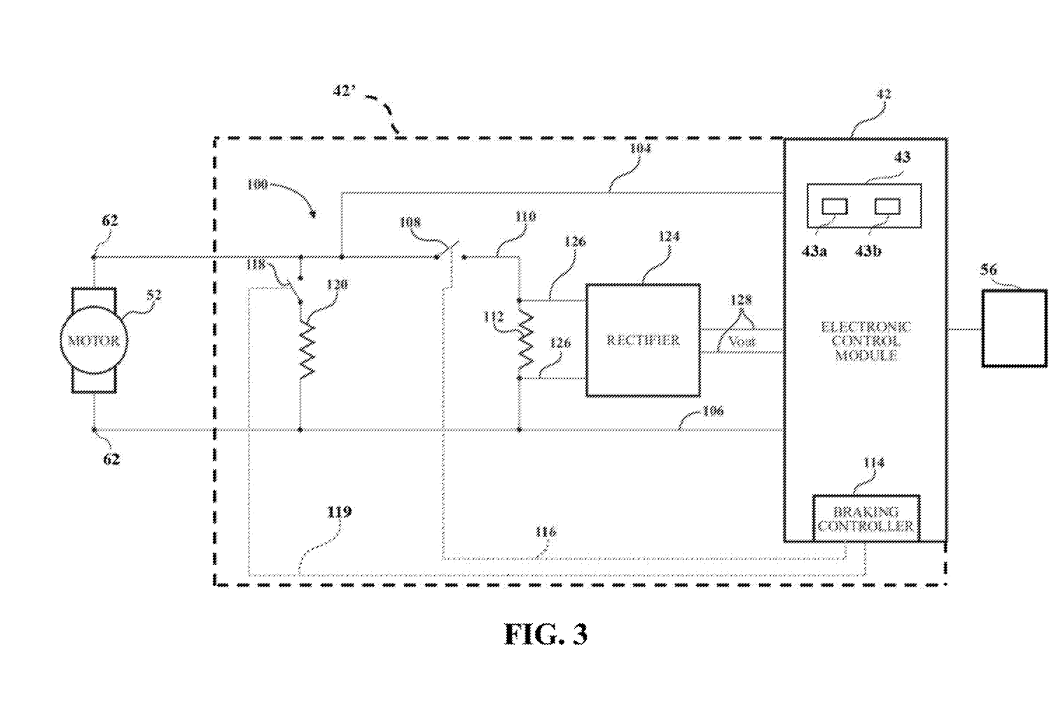

FIG. 3 is an electrical schematic of a braking circuit 100 for the powered garage door opener 10. The braking circuit 100 functions to regulate the speed of the shaft 26 when it is not actively powered by the electric motor 52, such as when the garage door 12 is manually moved, and without mains or utility line power being supplied to the powered garage door opener 10. Illustratively shown braking circuit 100 may be provided separate from and controlled by electronic control module 42, or be integrated with electronic control module 42′.

As shown in FIG. 3, the braking circuit 100 is controlled by electronic control module 42 to actively drive the electric motor 52 by providing electrical power thereto via a first conductor 104 and a second conductor 106, which may be called a “common” or “neutral” conductor, to cause the electric motor 52 to turn in either the first direction or in the second direction. The first and second directions of the electric motor 52 may correspond to opening and closing the garage door 12, respectively.

The electric motor 52 generates an induced voltage V_{ind} in response to application of an external force to the mechanical linkage. This external force may be a result of a person manually moving the garage door 12, for example upwardly UW or downwardly DW. Alternatively or additionally, the momentum of the garage door 12, once in motion, may cause the external force from the mechanical linkage to act upon the electric motor 52.

The garage door opener 10 of the present application also includes a first switch 108 operable in a soft braking mode to conduct electrical current from the electric motor 52 through a load to cause the electric motor 52 to apply a first braking force in opposition to the external force. The load may include a first braking resistor 112, as described above. The first switch 108 may take the form of a single-pole, single throw (SPST) switch, as shown in FIG. 3. In other embodiments, the first switch 108 may take the form of one or more different devices in a circuit that operate in conjunction to either conduct electrical current through the load or to block electrical current from being conducted through the load. The load may include other devices, such as a rectifier 124 to provide electrical power to one or more devices within the garage door opener 10 such as the motor drive controller.

In some embodiments, the first switch 108, may be configured to conduct electrical current from the electric motor 52 through the load with the powered garage door opener 10 in a manual mode in which the electric motor 52 is not actively driven by the electronic control module 42. The first switch 108 may also be operable in an non-braking condition to inhibit the flow of electrical current from the electric motor 52 through the load with the garage door opener 10 in an automatic mode in which the electric motor 52 may be actively driven by the electronic control module 42. The first switch 108 provides electrical continuity to allow electrical current to flow between the first conductor 104 and a third conductor 110 to conduct electrical current from the electric motor 52 to the load in a soft braking mode. In other words, the first switch 108 is in a conductive condition in the soft braking mode and is configured to inhibit the flow of electrical current from the electric motor 52 to the load when it is not in the soft braking mode.

A first braking resistor 112 is connected between the third conductor 110 and the second conductor 106 to provide a path for electrical current generated by the electric motor 52 as a result of the induced voltage V_{ind} electric motor 52 being rotated by an external force applied to the mechanical linkage. For example, the external force may be a rotary force applied to the shaft 26 as a result of the garage door 12 raising or lowering. The first braking resistor 112 may, dissipate power in the form of heat to cause the electric motor 52 to apply a first braking force in opposition to the external force applied to the shaft 26. In other words, the first switch 108 functions to connect the first braking resistor 112 across the electric motor 52 to provide the first braking force. The first braking resistor 112 may have a resistance of about 50 ohms, and may be, for example, 51 ohms. The first braking force may be minimal, and may be merely a byproduct of the main purpose of connecting the first braking resistor 112 across the electric motor 52, which is to generate electrical power, allowing the braking controller 114 to function. Alternatively, or additionally, the first braking force may be non-minimal, and may serve to reduce the speed of the electric motor 52, and the garage door 12.

According to an aspect, the first switch 108 may default to the soft braking mode with mains power, or utility power removed from the powered garage door opener 10. Alternatively, or additionally, the first switch 108 may default to the soft braking mode with powered garage door opener 10 operating in an “OFF” mode, for example, when a power ON/OFF switch deactivates the power supplied to the electronic control module 42, or electronic control module 42 is operating in a standby, or low power wait mode in anticipation of a wake-up signal in the form of a command for example from a wireless vehicle controller, a wired or wireless controller mounted to garage wall 14, a wireless key fob-type controller, a mobile phone/smart phone application, or any other type of transmitter for providing a control signal to module 42. The mains, or utility power, which is typically 120 VAC in North America, is used for normal, automatic operation of the powered garage door opener 10. The first switch 108 may also be placed into the soft braking mode anytime that the electric motor 52 is not actively turning the shaft 26, as determined by electronic control module 42. For example, after electronic control module 42 has determined the door 12 has reached a commanded position, such as fully opened or fully closed, or as another example when electronic control module 42 determines an object is present in the path of the door 12, and electronic control module 42 commands the motor 52 to stop to cease the motion of the door 12. Alternatively, the first switch 108 may be manually operated into the soft braking mode in response to the garage door opener 10 being in a “manual mode”, which may allow the garage door 12 to be manually opened or closed. In other words, when the electric motor 52 is being actively driven, the first braking resistor 112 may be electrically isolated from the electric motor 52 by the first switch 108 to ensure that power to the electric motor 52 is not transmitted to the first braking resistor 112. The first braking resistor 112 may be re-connected by closing the first switch 108 when that the electric motor 52 is not being actively driven. This may allow the first braking resistor 112 to provide braking, even after the electric motor 52 initiates motion.

As also shown in FIG. 3, the electronic control module 42 includes a braking controller 114 which is configured to monitor the speed of the garage door and to selectively command a second switch 118, which may be called a “hard brake switch,” to conduct the electrical current from the electric motor 52 through a second braking resistor 120 to cause the electric motor 52 to apply a second braking force in opposition to the external force. Illustratively, second switch 118 may be selectively controlled using a second control line 119 connected to braking controller 114. Similarly, illustratively first switch 108 may be selectively controlled using a first control line 116 connected to braking controller 114. In some embodiments, the second braking resistor 120 may have a significantly lower resistance than the first braking resistor 112 and may, therefore, cause the second braking force to be significantly greater than the first braking force. In some embodiments, the second braking resistor 120 may have a resistance value of about 5 ohms. However, it should be appreciated that the second braking resistor 120 may have a higher or lower value or a value that varies depending on the amount of braking required for a particular condition. In some embodiments, the second braking resistor 120 may have a power rating of 7 Watts. The power rating of the second braking resistor 120 may be higher or lower, depending on the requirements of a particular application, such as for example depending on the weight of the door 12, or the desired braking force and speed reduction desired when the braking force is applied to the motor 52. In some embodiments, the second braking force may be substantially larger than the first braking force.

The braking controller 114 may include any combination of hardware and/or software. In some embodiments, the motor drive controller 43 may include the braking controller 114. For example, the braking controller 114 may be a part of the electronic control module 42 as shown in the schematic of FIG. 3 as a separate unit for example as a separate microchip mounted on a common printed circuit board, or may for example be integrated into motor drive controller 43. In some embodiments, the braking controller 114 may be a software module running on a processor of the electronic control module 42. Alternatively, the braking controller 114 may be separate and independent from the electronic control module 42.

The second switch 118 may take the form of a single-pole, single throw (SPST) switch, as shown in FIG. 3. In other embodiments, the second switch 118 may take the form of one or more different devices in a circuit that operate in conjunction to either conduct electrical current through the second braking resistor 120 or to block electrical current from being conducted through the second braking resistor 120.

The switches 108, 118 may be manually or automatically operated, and may be relays, or include one or more transistors, such as FETs or BJTs. The switches 108, 118 may be similar or different from one other.

As also shown in FIG. 3, the braking circuit 100 includes a rectifier 124. Input conductors 126 connected to each side of the first braking resistor 112 are charged with the induced voltage V_{ind} and conduct an alternating current to transfer electrical power to the rectifier 124. The rectifier 124 functions to generate a direct current output voltage Vₒᵤₜ upon output conductors 128, providing power to the electronic control module 42. In other words, the rectifier 124 may convert alternating current and/or direct current having a positive or negative polarity from the input conductors 126 to a direct current output voltage Vₒᵤₜ upon output conductors 128, in a form required by the electronic control module 42, and/or for example by the brake controller 114. The rectifier 124 may include one or more diodes to provide the direct current output voltage Vₒᵤₜ that meets the requirements of the electronic control module 42, such as voltage, tolerable ripple, etc. The rectifier 124 may also include one or more other components such as, for example, resistors, capacitors, inductors, or voltage regulators.

According to a further aspect, application of the resistive load can also be varied based on position of the garage door 12. This may be accomplished by having two or more of the second braking resistors 120, each independently switchable by a corresponding second switch 118. Alternatively, or additionally, the braking controller 114 may vary the application of the second braking resistor 120, for example, by rapidly switching the second switch 118. This may be accomplished, for example, by pulse width modulation (PWM). At some positions the speed of the garage door 12 could be very critical to either protecting the function of the garage door 12, the electric motor 52, and/or other parts of the garage door assembly 13. For example, quickly raising the garage door 12 could cause the cable 25 to unspool from the pulley 24. For example, quickly lowering the garage door 12 could cause the door 12 to slam into the ground or an object.

In some embodiments, such as the embodiment of FIGS. 1-2, where the motor 52 is directly coupled to the pulley 24, excess braking in the upward direction as the garage door 12 approaches the top, or opened position can increase the difference in relative speed of the pulley 24 and the garage door 12, which may cause the cable 25 to lose tension. In other words, the electric motor 52 will slow the pulley 24, while the garage door 12 can be accelerated. This position is an example of a special consideration, which may call for reduced braking, as the weight of the garage door 12 that is being lifted by the external force is less so the garage door 12 is easier to accelerate. In other words, by being aware of the position of the garage door 12, the system of the present disclosure may vary the amount of braking in certain conditions to prevent damage to the garage door assembly 13, such as from the cable 25 being unspooled from the pulley 24. For example, a position sensor in communication with electronic control module 42 either directly configured to sense the position of the door 12, or indirectly configured, for example by sensing motor 52 rotations, may determine the position of the door 12. In some other embodiments, where the motor 52 is directly coupled to the door 12 through a direct drive connection that does not allow for lost motion between the movement of the motor 52 and the movement of the door 12, such as a cable would allow, and pulley 24 and spring 28 are separately coupled to the door 12, such that motor 52 is not directly coupled to pulley 24, such a special consideration may not exist, such that a braking of the motor 52 may be enabled when the door 12 is accelerated upwardly to allow the cable 25 to be properly spooled about the pulley 24.

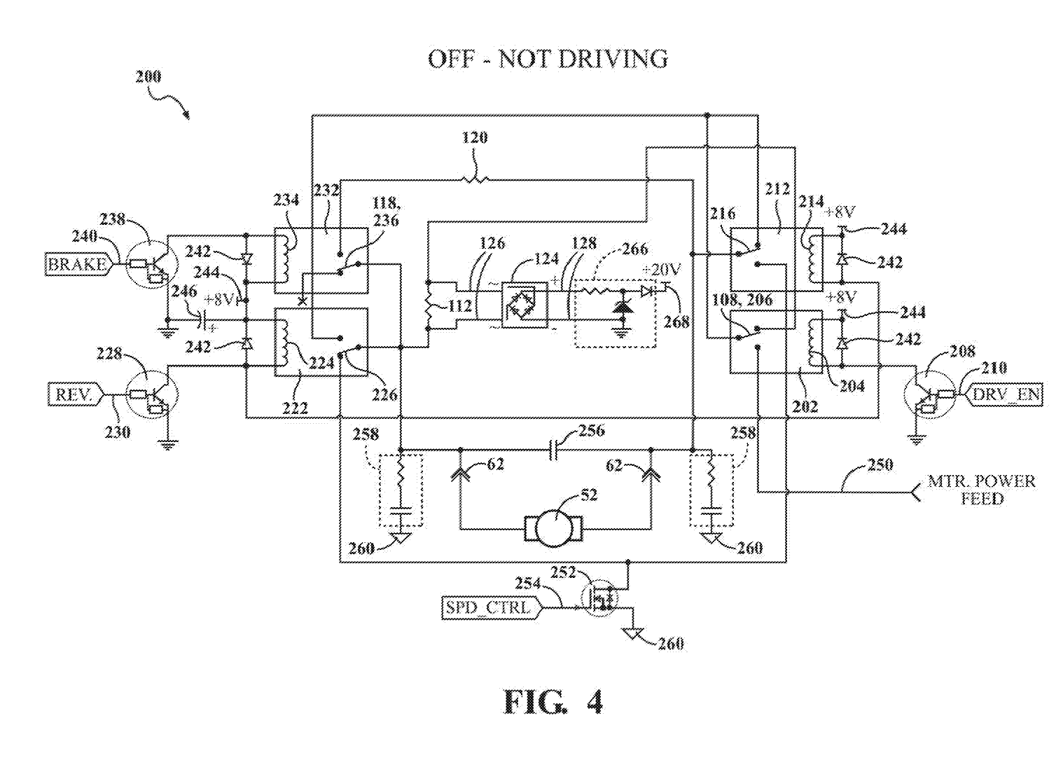

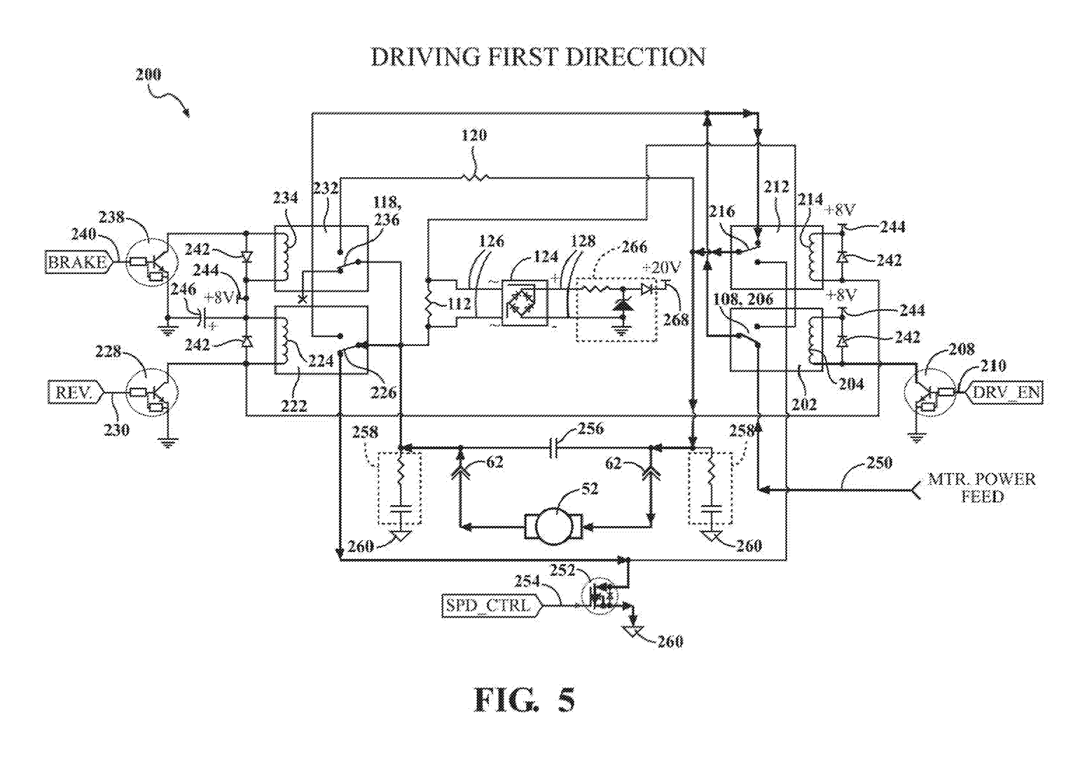

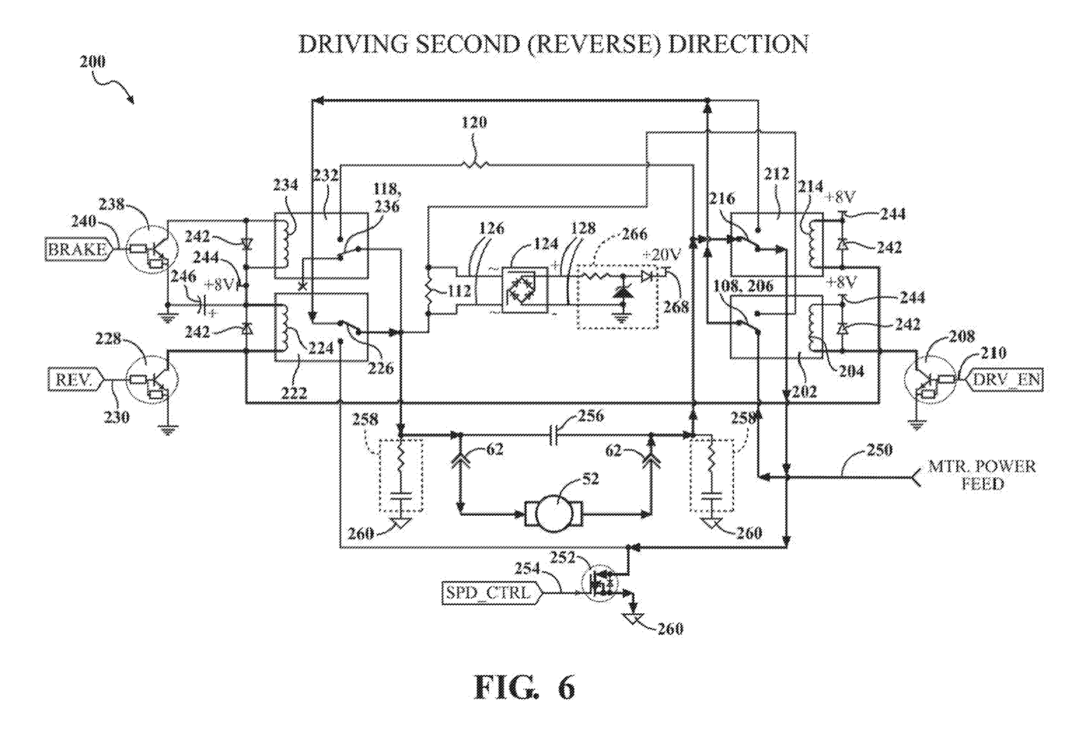

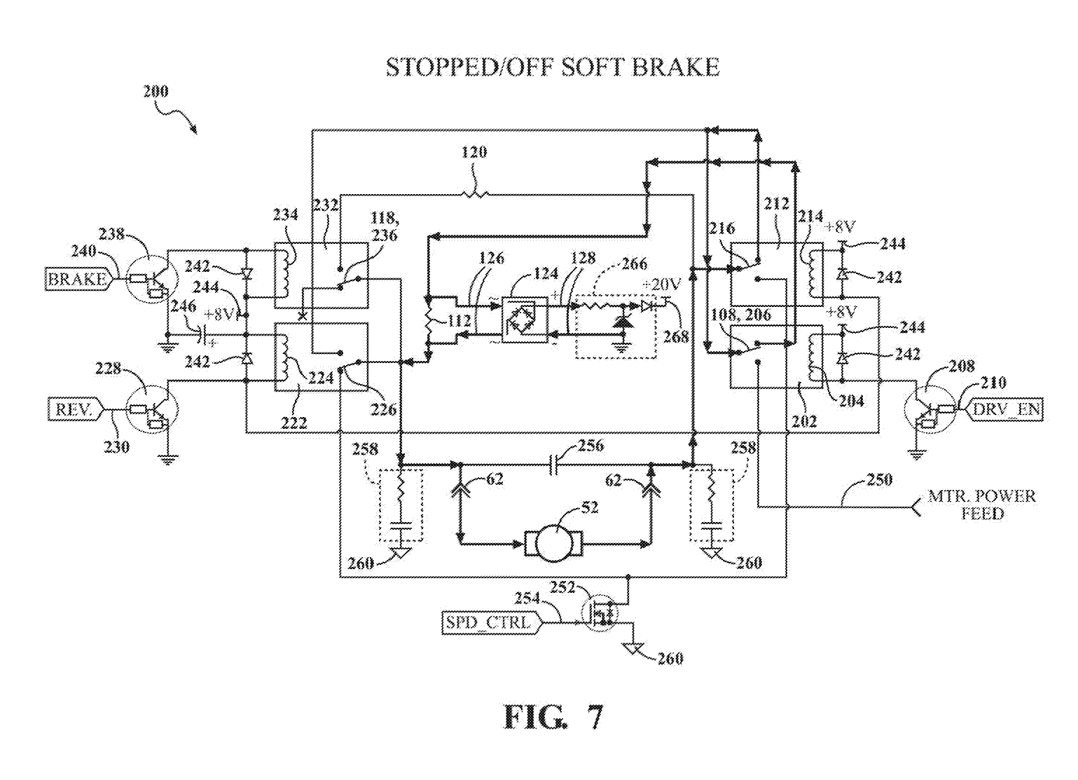

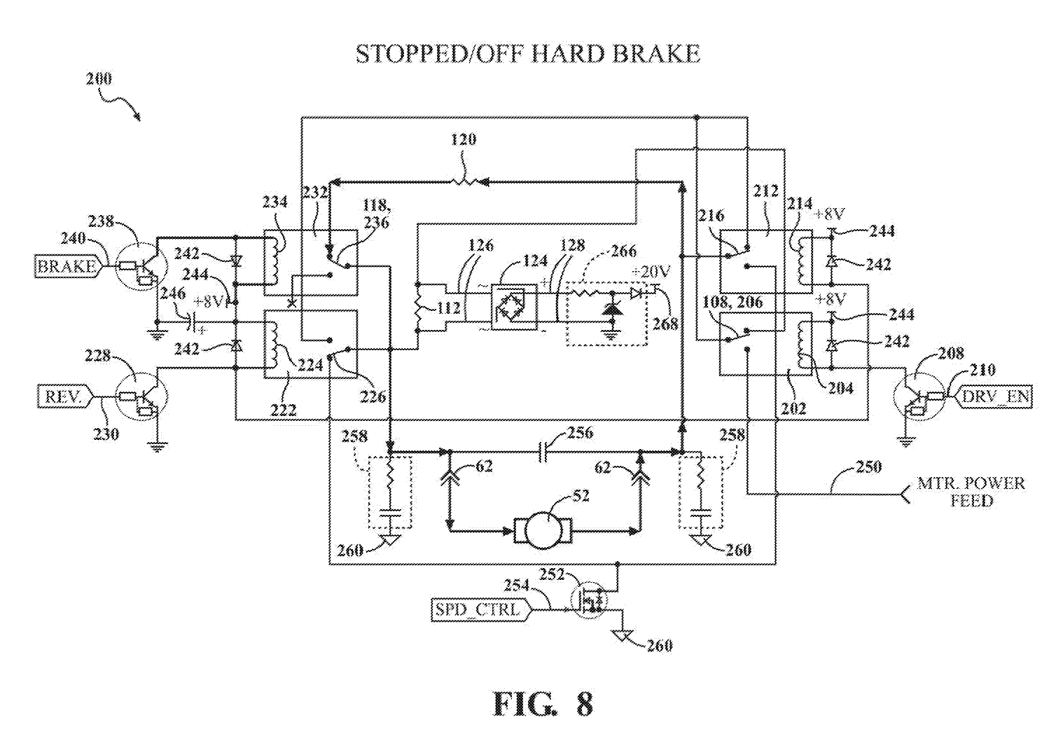

Referring now to FIGS. 4-8, a schematic diagram of a motor control circuit 200 in an example embodiment of the powered garage door opener 10 is shown. Motor control circuit 200 may be provided as part of the electronic control module 42, and for example be provided as part of a common printed circuit board supporting door motor controller 43. Alternatively, motor control circuit 200 may be provided separate from door control module 42. Each of FIGS. 4-8 show the motor control circuit 200 in a different operating mode, with bold lines illustrating conductors or devices that are energized or which carry electrical current in that particular operating mode. Specifically, FIG. 4 shows the motor control circuit 200 in an “OFF” operating mode where the electric motor 52 is not driven by either the electronic control module 42 or by an external force. FIG. 5 shows the motor control circuit 200 in a “DRIVING FIRST DIRECTION” operating mode where the electric motor 52 is driven in a first direction by the electronic control module 42. FIG. 6 shows the motor control circuit 200 in a “DRIVING SECOND (REVERSE) DIRECTION” operating mode where the electric motor 52 is driven in a second direction, opposite the first direction, by the electronic control module 42. FIG. 7 shows the motor control circuit 200 in a “STOPPED/OFF” operating mode and where the motor control circuit 200 is configured to cause the electric motor 52 to apply a first braking force, also called a “Soft Brake,” in opposition to an external force, such as by a person manually moving the garage door or by the garage door being pulled downwardly by the force of gravity. FIG. 8 shows the motor control circuit 200 in a “STOPPED/OFF” operating mode and where the motor control circuit 200 is configured to cause the electric motor to apply a second braking force, also called a “Hard Brake,” in opposition to the external force.

As shown in FIGS. 4-8, the motor control circuit 200 includes the electric motor 52 and the braking resistors 112, 120 as described, above. The motor control circuit 200 also includes a first relay 202 having a first coil 204 configured to actuate a first switching contact set 206 to change from a default or “normal” position shown on FIG. 4 with the first coil 204 de-energized to an “active” position shown on FIG. 5 with the first coil 204 energized. A drive enable transistor 208 is in electrical communication with the first coil 204 of the first relay 202 and is configured to energize the first coil 204 in response to assertion of a drive enable control line 210. The drive enable control line 210 allows the motor control circuit 200 to provide electrical power to the electric motor 52 for actively driving the powered garage door opener 10. The drive enable control line 210 may be asserted, or energized, by an output from a controller such as the electronic control module 42.

In the embodiment shown in FIGS. 4-8, the first switch 108 takes the form of the first switching contacts 206 of the first relay 202, which is operable in a braking mode, as shown in FIGS. 4 and 7, to cause electrical current induced by the electric motor 52 to be conducted through the first braking resistor 112. The first switch 108 is also operable in one or more non-braking modes, as shown in FIGS. 5 and 6, in which electrical current flowing through the electric motor 52 is prevented from being conducted through the first braking resistor 112.

The motor control circuit 200 also includes a second relay 212 having a second coil 214 configured to actuate a second switching contact set 216 to change from a default or “normal” position shown on FIG. 4 with the second coil 214 de-energized to an “active” position shown on FIG. 6 with the second coil 214 energized. The motor control circuit 200 also includes a third relay 222 having a third coil 224 configured to actuate a third switching contact set 226 to change from a default or “normal” position shown on FIG. 4 with the third coil 224 de-energized to an “active” position shown on FIG. 6 with the third coil 224 energized. In the embodiment of FIGS. 4-8, a direction-control transistor 228 is in electrical communication with both the second coil 214 of the second relay 212 and the third coil 224 of the third relay 222. The direction control transistor 228 is configured to energize each of the second and third coils 214, 224 in response to assertion of a direction control line 230. The direction control line 230 allows the motor control circuit 200 to change the polarity of electrical power supplied to the electric motor 52 for causing the powered garage door opener 10 to operate in either a forward or a reverse direction. The forward and reverse directions each correspond to either opening or closing the garage door 12. The direction control line 230 may be asserted, or energized by an output from a controller such as the electronic control module 42.

The motor control circuit 200 also includes a fourth relay 232 having a fourth coil 234 configured to actuate a fourth switching contact set 236 to change from a default or “normal” position shown on FIG. 4 with the fourth coil 234 de-energized to an “active” position shown on FIG. 8 with the fourth coil 234 energized. A brake control transistor 238 is in electrical communication with the fourth coil 234 of the fourth relay 232 and is configured to energize the fourth coil 234 in response to assertion of a brake control line 240. The brake control line 240 may be asserted, or energized, by an output from a controller such as the electronic control module 42.

Each of the switching contact sets 206, 216, 226, 236 are shown as a single form-C type of contacts, with a common terminal and a wiper that selectively disconnects the common terminal from electrical communication with a normally-closed terminal and connects the common terminal into electrical communication with a normally-open terminal in response to a corresponding one of the coils 204, 214, 224, 234 being energized. It should be appreciated that any or all of the relays 202, 212, 222, 232 could have other configurations, including different arrangements of the contact sets 206, 216, 226, 236. It should also be appreciated that any or all of the relays 202, 212, 222, 232 could take other forms, such as a circuit including one or more relays and/or solid-state devices.

Each of the coils 204, 214, 224, 234 has a flyback diode 242 connected thereacross. The flyback diodes 242 are configured to be reverse-biased and non-conductive during normal operation. The flyback diodes 242 are each configured to conduct transient voltage caused by collapsing magnetic fields in the corresponding ones of the coils 204, 214, 224, 234, preventing the transient voltages from damaging other components, such as the transistors 208, 228, 238.

A control power node 244 is electrically connected to supply a control power of +8V to each of relay coils 204, 214, 224, 234. An end of each of relay coil 204, 214, 224, 234 opposite the control power node 244 is switched to conduct current to an earth ground by a corresponding one of the drive enable transistor 208, the direction control transistor 228, or the brake control transistor 238. This allows corresponding ones of the relay coils 204, 214, 224, 234 to be energized by corresponding controller outputs that are not capable of supplying the voltage and/or current required to energize the relay coils 204, 214, 224, 234. A control power capacitor 246 is connected between the control power node 244 and the earth ground to supply an inrush current to one or more of the relay coils 204, 214, 224, 234 and maintain the voltage upon the control power node 244. The control power node 244 may have a different voltage than +8V, and one or more of the relay coils 204, 214, 224, 234 may bay be arranged with a switched-positive configuration in which the relay coil is energized by switching the control power node 244 into communication with the relay coil, instead of the switched-neutral configuration of the embodiment shown. Each of the drive enable transistor 208, the direction control transistor 228, and the brake control transistor 238 are shown on FIGS. 4-8 as bipolar junction transistors. However, it should be appreciated that any or all of them may be other types of devices, such as field effect transistors.

As also shown in FIGS. 4-8, a power feed conductor 250 provides electrical power for driving the electric motor 52. A power control transistor 252 is configured to switch electrical current from the electric motor 52 to a signal ground 260 in response to assertion of a power signal line 254. The power signal line 254 may be asserted, or energized, by an output from a controller such as the electronic control module 42. The power line signal 254 may be rapidly switched, for example by a pulse-width modulation (PWM) signal to control the amount of electrical current supplied to the electric motor 52, and to thereby control the torque and/or the speed of the electric motor 52. It should be appreciated that the power control transistor 252 could also be arranged in a different configuration to switch a positive voltage from the power feed conductor 250, with another conductor from the electric motor 52 being directly connected to a current sink, such as the signal ground 260. The power control transistor 252 shown on FIGS. 4-8 is a metal oxide field-effect transistor (MOSFET). However, it should be appreciated that the power control transistor 252 may a different type of device, such as a bipolar junction transistor or a different kind of field effect transistor.

A filter capacitor 256 is connected across the terminals of the electric motor and serves to reduce electromagnetic interference, or noise, from being generated by the electric motor 52. An RC filter 258 having a resistor and a capacitor connected in series, is also connected between each of the terminals of the electric motor and the signal ground 260 to reduce electromagnetic interference from being transferred to other components of the motor control circuit 200.

A motor drive controller 43 is configured to provide electrical power to the electric motor 52 to cause the electric motor 52 to apply a driving torque to the mechanical linkage for raising or lowering the garage door 12. The motor drive controller 43 may be included as part of the electronic control module 42 described above. The electronic control module 42 may also include one or more components within a motor control circuit 200, such as the power control transistor 252 and/or one or more of the relays 202, 212, 222, 232 described above with reference to FIGS. 4-8. Control lines 210, 230, 240, 254 may be in electrical connection with control ports (not shown) of motor drive controller 43.

In operation, when the motor control circuit 200 is not driven by the electronic control module 42, each of the relay coils 204, 214, 224, 234 de-energized, and the switching contact sets 206, 216, 226, 236 are in their “normal” configurations, with the first braking resistor 112 connected across terminals of the electric motor 52, such as in the an “STOPPED/OFF” operating mode of FIG. 4. or FIG. 7. The only difference between the conditions illustrated in FIG. 4 and FIG. 7 is that there is no current motor control circuit of FIG. 4, and there is an induced current in FIG. 7 from the electric motor 52 through the first braking resistor 112. In the “STOPPED/OFF” configuration shown in FIG. 4, the second switch 118, in the form of the fourth switching contacts 236 of the fourth relay 232, inhibits electrical current from the electric motor 52 from flowing through the second braking resistor 120.

Referring now to FIG. 7, some of the induced current from the electric motor 52 flows through the rectifier 124 via the input conductors 126. In other words, the first braking resistor 112 and the rectifier 124 function together as the load for the current generated by the electric motor 52. In some embodiments, the rectifier 124 may be the only load, and the first braking resistor 112 may be omitted. The rectifier 124 provides a rectified power output upon a set of output conductors 128 using electrical energy from the electrical current supplied by the electric motor 52. A power regulator 266 is connected to the output conductors 128 to produce a regulated voltage on a supplemental power node 268. This regulated voltage may be +20V as shown on FIGS. 4-8. In some embodiments, the regulated voltage may have a different value. The regulated voltage provided by the power regulator 266 may be provided to the braking controller 114, described above, for allowing the braking controller 114 to selectively control the hard brake.

In some embodiments, and as shown in FIGS. 4-8, the rectifier 124 may be a full bridge rectifier configured to rectify electrical current in either of a positive or a negative polarity to provide the rectified power output. Alternatively, the rectifier 124 may be a half-wave device configured to provide the rectified power output from only positive or negative voltages between the input conductors.

Referring now to FIG. 5, the drive enable control line 210 is asserted, causing the first coil 204 of the first relay 202 to be energized. The direction control line 230 and the brake control line 240 are both not asserted. The remaining relay coils 214, 224, 234 are all de-energized, causing the associated switching contacts 216, 226, 236 to be in their “normal” conditions, as shown. The power signal line 154 is also asserted, causing the power control transistor 252 to conduct electrical current from the power feed conductor 250 to flow through the electric motor 52 in a first direction, as shown. That flow of electrical current causes the electric motor 52 to drive in the first direction. With the motor control circuit 200 in the configuration shown in FIG. 5, electrical current is blocked from flowing through each of the first and second braking resistors 112, 120.

Referring now to FIG. 6, the drive enable control line 210 is asserted, causing the first coil 204 of the first relay 202 to be energized. The direction control line 230 is also asserted, causing both of the second relay coil 212 and the third relay coil 222 to be energized. The brake control line 240 is not asserted, causing the fourth relay coil 232 to be de-energized. The power signal line 154 is also asserted, causing the power control transistor 252 to conduct electrical current from the power feed conductor 250 to flow through the electric motor 52 in a second direction opposite the first direction, as shown. That flow of electrical current causes the electric motor 52 to drive in the second direction. With the motor control circuit 200 in the configuration shown in FIG. 6, electrical current is blocked from flowing through each of the first and second braking resistors 112, 120.

Referring now to FIG. 8, the brake control line 240 is asserted, causing the fourth coil 234 of the fourth relay 232 to be energized. The drive enable control line 210 and the direction control line 230 are both not asserted. The remaining relay coils 204, 214, 224 are all de-energized. In other words, FIG. 8 shows the motor control circuit 200 in the “Hard Brake” configuration. In this configuration, the second switch 118 takes the form of the fourth switching contacts 236 of the fourth relay 232, causing electrical current induced by the electric motor 52 to be conducted through the second braking resistor 120. The second braking resistor 120 dissipates electrical energy as heat and causes the electric motor 52 to apply the second braking force in opposition to the external force, as described above.

In some embodiments, the garage door opener 10 may include a speed sensor configured to monitor a speed of the electric motor 52 or the mechanical linkage. For example, the speed sensor may include an optical encoder configured to measure optical signals that change with movement of the mechanical linkage. The speed sensor may take other forms, such as a magnetic sensor. Alternatively or additionally, the speed sensor may include hardware or software configured to determine the speed of the electric motor 52 based upon one or more characteristics of voltage or current on the electrical terminals of the electric motor. For example, the electric motor 52 may induce a voltage across its terminals with a frequency that varies with the speed of the electric motor, and the speed sensor may be configured to monitor the speed of the electric motor by measuring that frequency.

In some embodiments, the first switch 108 is configured to be in the soft braking mode with utility line power removed from the garage door opener 10. This is shown schematically in FIG. 4, as described above. Alternatively or additionally, the first switch 108 is configured to be in the soft braking mode when the garage door opener 10 is switched “OFF”, or the electronic control module 42 is in a standby mode or state. Electronic control module 42 may be configured to ensure that the first switch 108 is configured to be in the soft braking mode, for example in response to the garage door opener 10 being switched “OFF”, in response to detection of the loss of utility line power, or in response to the electronic control module 42 changing to a standby state, for example after having commanded the motor 52 to move the door 12. In some embodiments, the first switch 108 is configured to be in the soft braking mode with the garage door opener 10 in a manual mode in which the motor drive controller is prevented from supplying power to the electric motor 52. Likewise, the first switch 108 may be in a non-braking mode inhibiting electrical current from the electric motor 52 from flowing through the load with the garage door opener 10 in an automatic mode with the motor drive controller able to supply power to the electric motor 52. An example of the manual mode is where the drive enable control line 210 is not asserted, such as in FIGS. 4 and 7. An example of the automatic mode is where the where the drive enable control line 210 is asserted, such as in the driving modes shown in FIGS. 5 and 6.

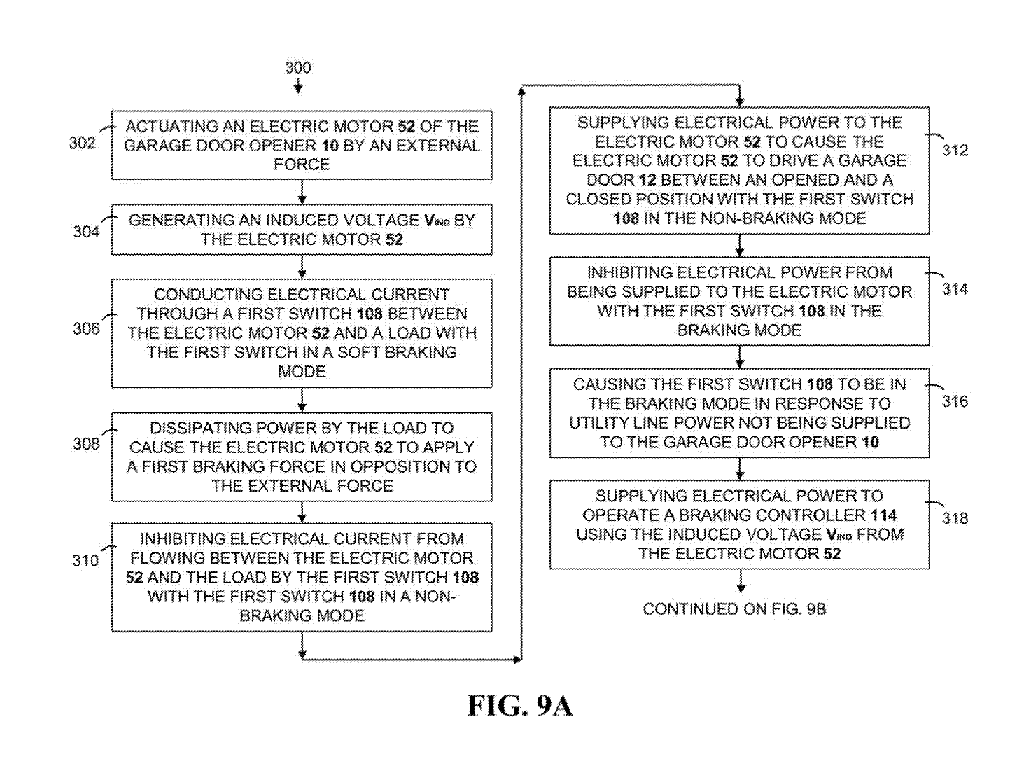

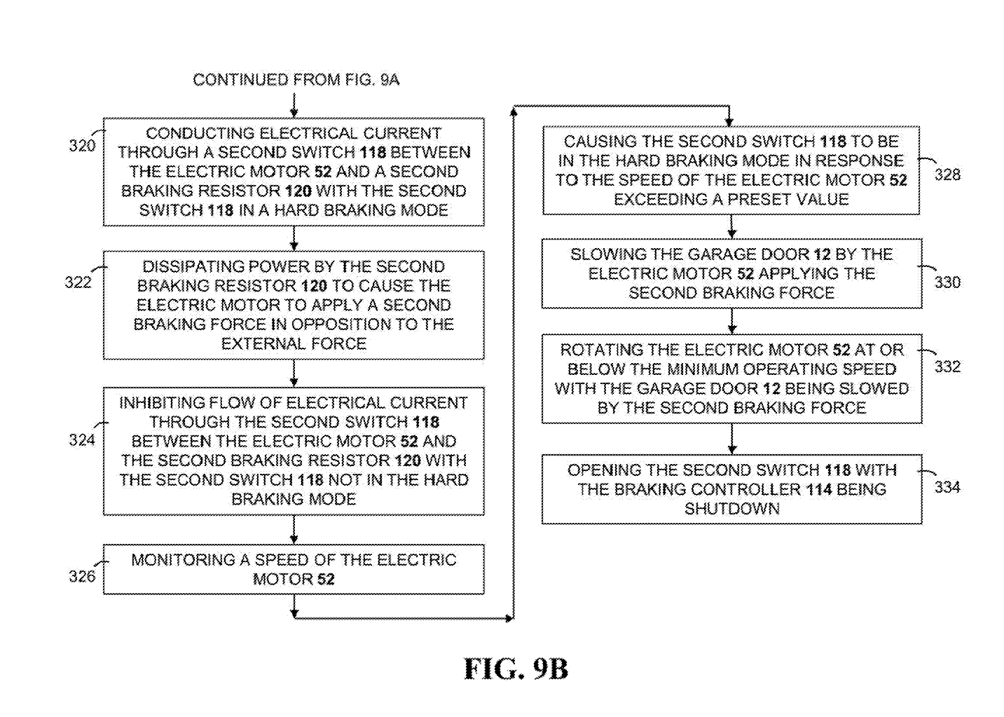

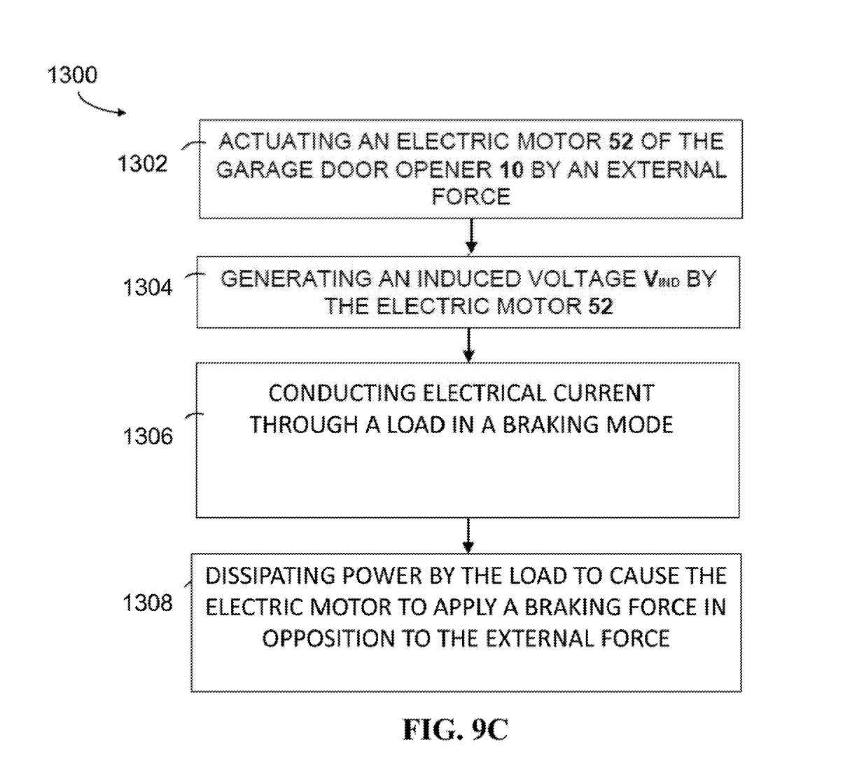

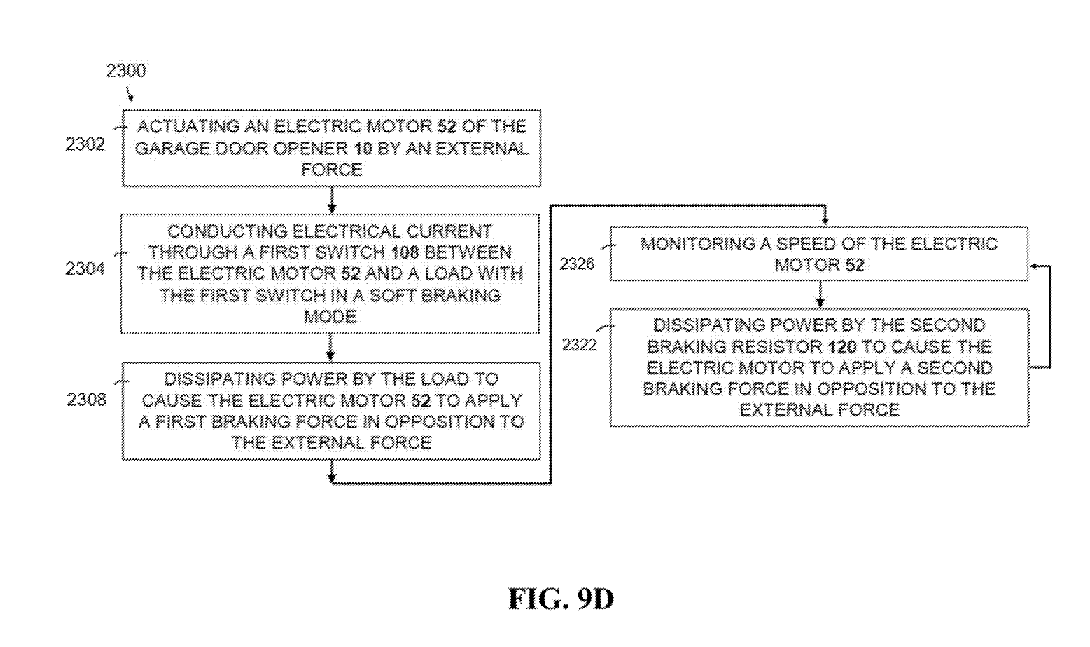

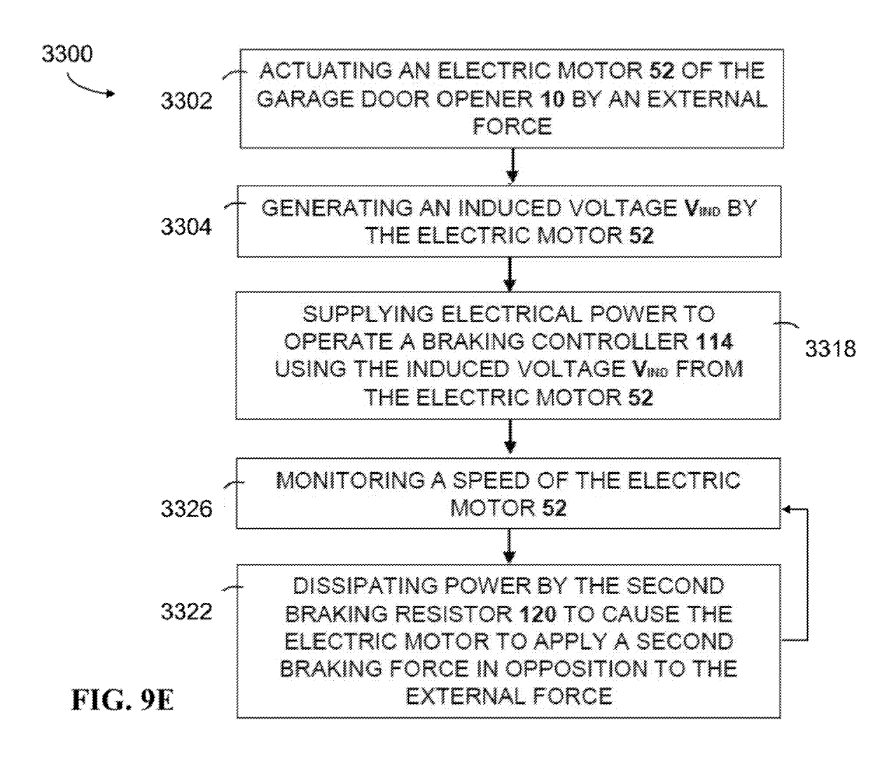

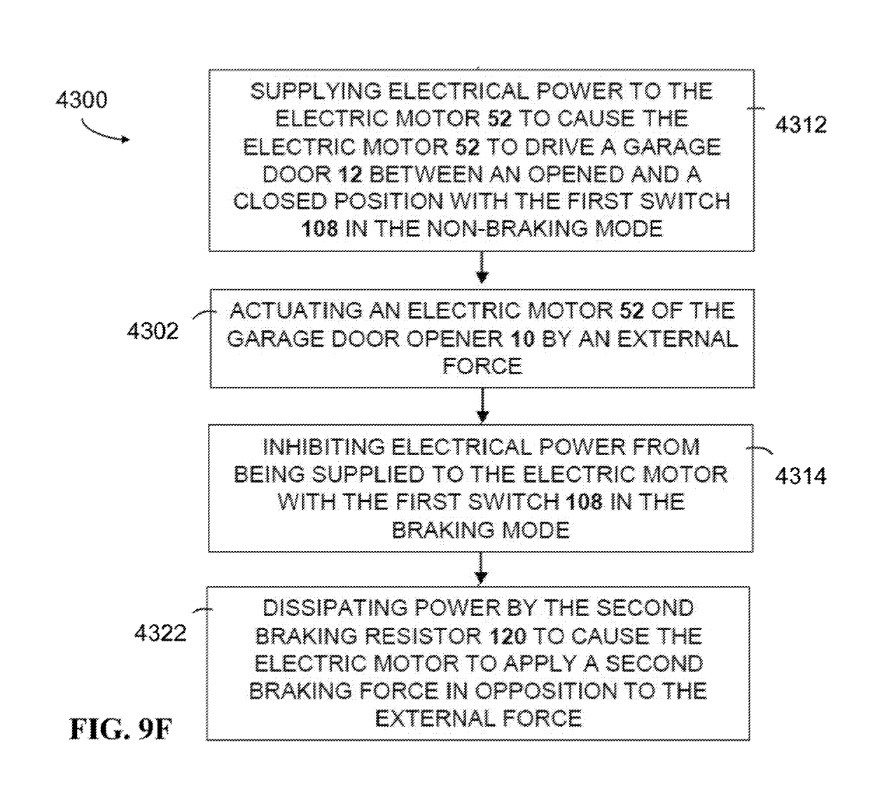

As shown in the flow chart of FIGS. 9A-9B, a method 300 for operating a braking circuit 100 of a powered garage door opener 10 is also provided. The method 300 includes actuating an electric motor 52 of the garage door opener 10 by an external force at step 302. The external force is any force except driving forces generated by the electric motor 52 by application of electrical power to the electric motor 52. The external force may include forces applied to the garage door 12, such as a manual opening or closing force, or force due to the pull of gravity on the garage door 12.

The method 300 also includes generating an induced voltage V_{ind} by the electric motor 52 at step 304. In other words, the electric motor 52 may function as a generator to generate the induced voltage V_{ind}, particularly where the electric motor 52 is acted upon by the external force.

The method 300 also includes conducting electrical current through a first switch 108 between the electric motor 52 and a load with the first switch in a soft braking mode at step 306. In some embodiments, the load may include a first braking resistor 112 such as a five ohm resistor, described above. In some embodiments, the load may include a power converter, which may include a rectifier 124, a DC-DC power supply, and/or other circuitry, and which may be configured to supply electrical power to a controller or other circuitry.

The method 300 also includes dissipating power by the load to cause the electric motor 52 to apply a first braking force in opposition to the external force at step 308. An example of this step 308 is described above with reference to FIG. 7.

The method 300 also includes inhibiting electrical current from flowing between the electric motor 52 and the load by the first switch 108 with the first switch 108 in a non-braking mode at step 310. An example of this step 310 is described above with reference to FIGS. 5-6.

The method 300 may also include supplying electrical power to the electric motor 52 to cause the electric motor 52 to drive a garage door 12 between an opened and a closed position with the first switch 108 in the non-braking mode at step 312. An example of this step 312 is described above with reference to FIGS. 5-6.

The method 300 may also include inhibiting electrical power from being supplied to the electric motor with the first switch 108 in the braking mode at step 314.

The method 300 may also include causing the first switch 108 to be in the braking mode in response to utility line power not being supplied to the garage door opener 10 at step 316. An example of this step 316 is described above with reference to FIG. 4.

The method 300 may also include supplying electrical power to operate a braking controller 114 using the induced voltage V_{ind} from the electric motor 52 at step 318. In some embodiments, this step 318 may be performed by a power converter, which may include a rectifier 124. This step 318 may include supplying a regulated voltage to a supplemental node 268, as described above.

The method 300 may also include conducting electrical current through a second switch 118 between the electric motor 52 and a second braking resistor 120 with the second switch 118 in a hard braking mode at step 320. An example of this step 320 is described above with reference to FIG. 8.

The method 300 may also include dissipating power by the second braking resistor 120 to cause the electric motor to apply a second braking force in opposition to the external force at step 322. An example of this step 322 is described above with reference to FIG. 8. In some embodiments, the second braking force may be substantially larger than the first braking force.

The method 300 may also include inhibiting flow of electrical current through the second switch 118 between the electric motor 52 and the second braking resistor 120 with the second switch 118 not in the hard braking mode at step 324. An example of this step 324 is described above with reference to FIG. 4.

The method 300 may also include monitoring a speed of the electric motor 52 at step 326. This step 326 may including using a speed sensor, such as an encoder, as described above. Alternatively or additionally, this step 326 may include monitoring one or more electrical characteristics of the electric motor 52.

The method 300 may also include causing the second switch 118 to be in the hard braking mode in response to the speed of the electric motor 52 exceeding a preset value at step 328. This step 328 may involve comparing the speed of the electric motor 52, as measured by the speed sensor at step 326, against the preset value. This step 328 may be performed by the braking controller 114.

The method 300 may also include slowing the garage door 12 by the electric motor 52 applying the second braking force at step 330. In some embodiments, where the second braking force is greater than the first braking force, this step 330 may account for the majority of the braking action of the braking circuit 100.

In some embodiments, steps 326 through 330 may only be available after the electric motor 52 has rotated at or above a minimum operating speed for a predetermined period of time, allowing the electric motor 52 to generate a sufficient amount of electrical power for a sufficient period of time to allow the braking controller 114 to function. This initialization period of time may take about 150 milliseconds and may allow, for example, the processor of the braking controller 114 boot up and to begin running program instructions to perform the actions of steps 326 through 330.

The method 300 may also include rotating the electric motor 52 at or below the minimum operating speed with the garage door 12 being slowed by the second braking force at step 332. This step 332 of slowing the garage door 12 may thereby result in a reduction of the induced voltage V_{ind}, which can cause the braking controller 114 to shutdown due to a lack of electrical power. The shutdown may be delayed by storing electrical energy in a capacitor or a battery.

The method 300 may also include opening the second switch 118 with the braking controller 114 being shutdown at step 334. In other words, second switch 118 may return to its “normal” or default condition after braking controller 114 is no longer available to command it to be in the hard braking mode. This step 334, thereby results in the second switch 118 disconnecting the second braking resistor 120 from the electric motor 52, and thereby removing the second braking force, and leaving the electric motor 52 to apply the first braking force. This step 334 may be considered returning to step 302 to repeat the process over again.

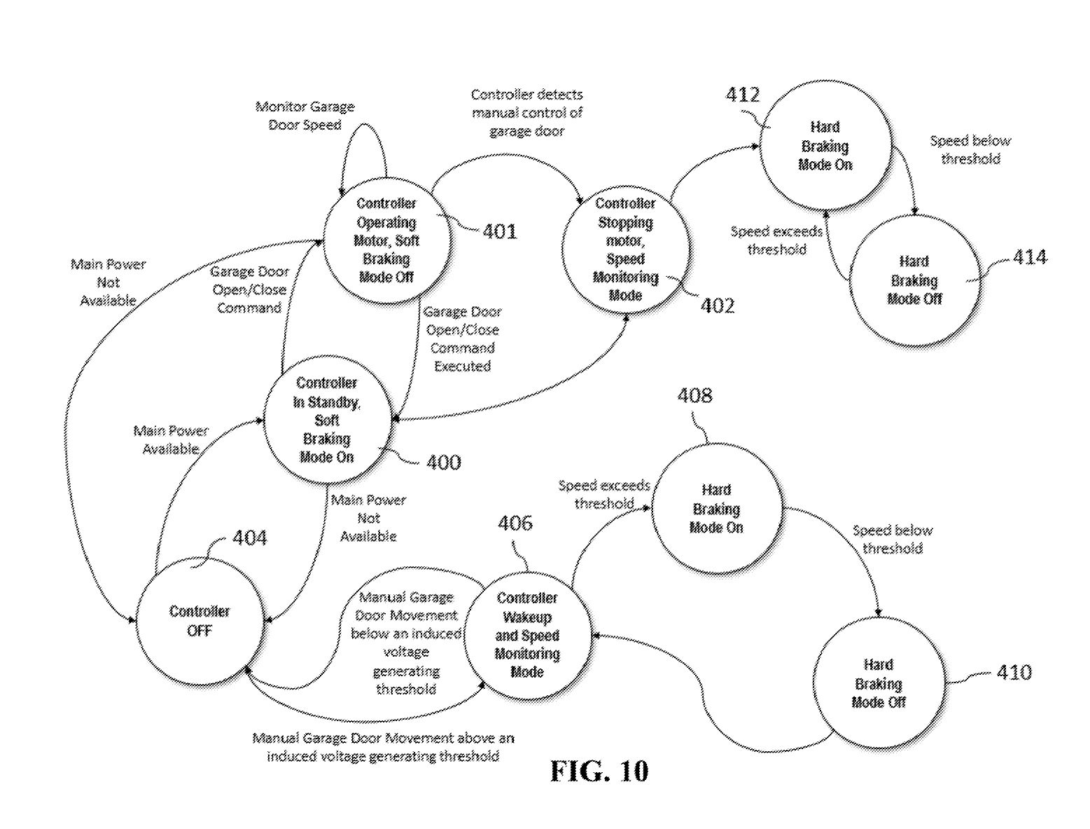

Now referring to FIG. 9C and FIG. 10, in accordance with another illustrative method 1300 for operating a braking circuit 100 of a powered garage door opener 10 when electronic control module 42 is operating in a controller stopping motor state 402 is also provided. The method 1300 includes actuating an electric motor 52 of the garage door opener 10 by an external force at step 1302. The method 1300 also includes generating an induced voltage V_{ind} by the electric motor 52 at step 1304. In other words, the electric motor 52 may function as a generator to generate the induced voltage V_{ind}, particularly where the electric motor 52 is acted upon by the external force. The method 1300 also includes conducting electrical current through a load, for example by operating a first switch 108 between the electric motor 52 and a load with the first switch 108 in a soft braking mode at step 1306. The method 1300 also includes dissipating power by the load to cause the electric motor 52 to apply a first braking force in opposition to the external force at step 1308.

Now referring to FIG. 9D and FIG. 10, in accordance with another illustrative method 2300 for operating a braking circuit 100 of a powered garage door opener 10 when electronic control module 42 is operating in a controller off state 404 is also provided. The method 2300 includes actuating an electric motor 52 of the garage door opener 10 by an external force at step 2302. The method 2300 also optionally includes conducting electrical current through a load, for example by operating a first switch 108 between the electric motor 52 and a load with the first switch 108 in a soft braking mode at step 2304. The method 2300 also includes dissipating power by the load to cause the electric motor 52 to apply a first braking force in opposition to the external force at step 2308. The method 300 may also include monitoring a speed of the electric motor 52 at step 2326. The method 2300 may also include dissipating power by the second braking resistor 120 to cause the electric motor to apply a second braking force in opposition to the external force at step 2322.

Now referring to FIG. 9E and FIG. 10, in accordance with another illustrative method 3300 for operating a braking circuit 100 of a powered garage door opener 10 when electronic control module 42 is operating in a controller OFF state 402. The method 3300 includes actuating an electric motor 52 of the garage door opener 10 by an external force at step 3302. The method 3300 also includes generating an induced voltage V_{ind} by the electric motor 52 at step 3304. In other words, the electric motor 52 may function as a generator to generate the induced voltage V_{ind}, particularly where the electric motor 52 is acted upon by the external force. The method 3300 may also include supplying electrical power to operate a braking controller 114 and/or the electronic control module 42 using the induced voltage V_{ind} from the electric motor 52 at step 3318. The method 300 may also include monitoring a speed of the electric motor 52 at step 3326. The method 3300 may also include dissipating power by the second braking resistor 120 to cause the electric motor to apply a second braking force in opposition to the external force at step 3322. The method 300 may also include returning to the step of monitoring a speed of the electric motor 52 at step 3326.

Now referring to FIG. 9F and FIG. 10, in accordance with another illustrative method 4300 for operating a braking circuit 100 of a powered garage door opener 10 with the electronic control module 42 in a controller operating motor state 401. The method 300 may also include supplying electrical power to the electric motor 52 to cause the electric motor 52 to drive a garage door 12 between at least one of an opened and a closed position, for example with the first switch 108 in the non-braking mode at step 4312. The method 4300 may also include inhibiting electrical power from being supplied to the electric motor with the first switch 108 in the braking mode at step 4314. The method 4300 may also include dissipating power by the second braking resistor 120 to cause the electric motor 52 to apply a second braking force in opposition to the external force at step 4322.

Now referring to FIG. 10, there is illustrated a state diagram of the electronic control module 42 operating in various power and braking modes, such that the electronic control module 42 may control the application of a braking force to the motor 52 in various operating states of the garage door opener 10, and for example even when the electronic control module 42 has been disconnected from a utility power source for providing improved safety and damage mitigation to the garage door opener 12. For example, the electronic control module 42 may operate in a controller in standby state 400 where the electronic control module 42 may be powered ON receiving main utility power and be in standby to receive a door opening or closing command. When the electronic control module 42 is in the controller in standby state 400, the soft braking mode is ON and first switch 108 is configured to conduct electrical current, for example as determined by electronic control module 42 after the motor 52 has been commanded to stop, after detecting a loss of power of utility main power, or a power OFF switch of the garage door 12 activated. Illustrated in FIG. 10 of such an event is the electronic control module 42 transitioning to a Controller OFF state 404. In the Controller OFF state 404, the electronic control module 42 may be operating in the soft braking mode, but it is recognized that the electronic control module 42 may not be operating in the soft braking mode, for example, if a utility power failure causes a shutdown of electronic controller module 42 before executing control commands to activate first switch 108. In the Controller OFF state 404, FIG. 10 illustrates that a manual movement of the motor 52 by the external force may provide the generation of power to be supplied to the electronic controller module 42 for powering the electronics, such as the braking controller 114, in order to monitor the speed of the garage door 12 in a Controller Wakeup Mode and Speed Monitoring Mode 406 and correspondingly in response to detecting the manual movement of the garage door 12 enter into a Hard Braking Mode On 408 in response to the electronic control module 42 detecting the motor 52 or the door 12 moving above a threshold speed whereby the second switch 108 is activated to direct current to the hard braking resistor for example, and enter into a Hard Braking Mode Off 410 in response to the electronic control module 42 detecting the motor 52 or the door 12 moving below a threshold speed whereby the second switch 108 is deactivated to not direct current to the hard braking resistor for example. As a result of the applied braking force, for example the electronic control module 42 may return to the Controller OFF state 404, as a result of the external force being insufficient to drive the motor 52 to cause the generation of power to be supplied to the electronic controller module 42 for powering the electronics, such as the braking controller 114. If the door 12 movement again causes the external force being sufficient to drive the motor 52 to cause the generation of power to be supplied to the electronic controller module 42 for powering the electronics, the electronic control module 42 will again transition to the Controller Wakeup Mode and Speed Monitoring Mode 406.

When electronic control module 42 is operating the controller in standby state 400 where the electronic control module 42 may be powered ON receiving main utility power and receives a door opening or closing command, electronic control module 42 may transition to a Controller Operating Motor and Soft Braking Mode Off State 401, whereby for example the electronic control module 42 configures the first switch 108 to not conduct electrical current from the electric motor 52 through the load. In Controller Operating Motor and Soft Braking Mode Off State 401, the electronic control module 42 may be configured to detect and monitor the speed of at least one of the motor 52 and the door 12. If the electronic control module 42 determines a user has manual control of the door 12, for example as determined by a difference in the speed of the motor 52 and the speed of the door 12, or by as determined based on a difference in the rotational speed of the motor 52 and an expected rotational speed based on the power supplied to the motor 52. In response to detecting a manual control of the door 12, the electronic control module 42 may transition to a Controller Stopping motor and Speed Monitoring Mode State 402, whereby the electronic control module 42 will command the motor 52 to stop, and whereby the electronic control module 42 will determine to operate the braking circuit 100 in a hard braking mode, for example in the Hard Braking Mode On State 412, based on detecting the speed of the motor 52 or the garage door 12, and for example operate the second switch 118 to selectively apply a braking force to the motor 52 and door 12 when the door 12 or motor 52 is above a threshold speed, and operate the second switch 118 to selectively remove a braking force to the motor 52 when the speed of the motor 52 or door 12 is below a threshold speed, for example in the Hard Braking Mode Off State 414, with such a threshold speed stored in memory 43b as a predefined variable.

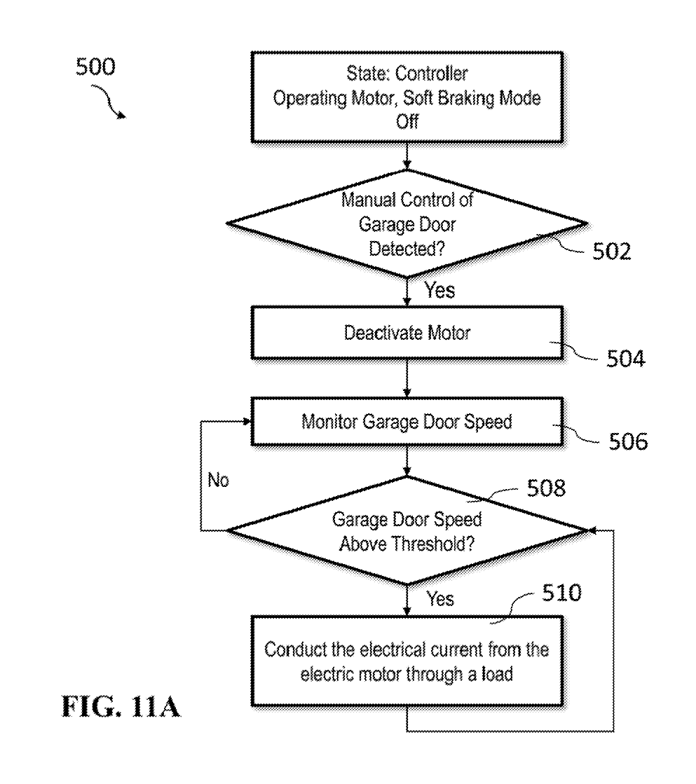

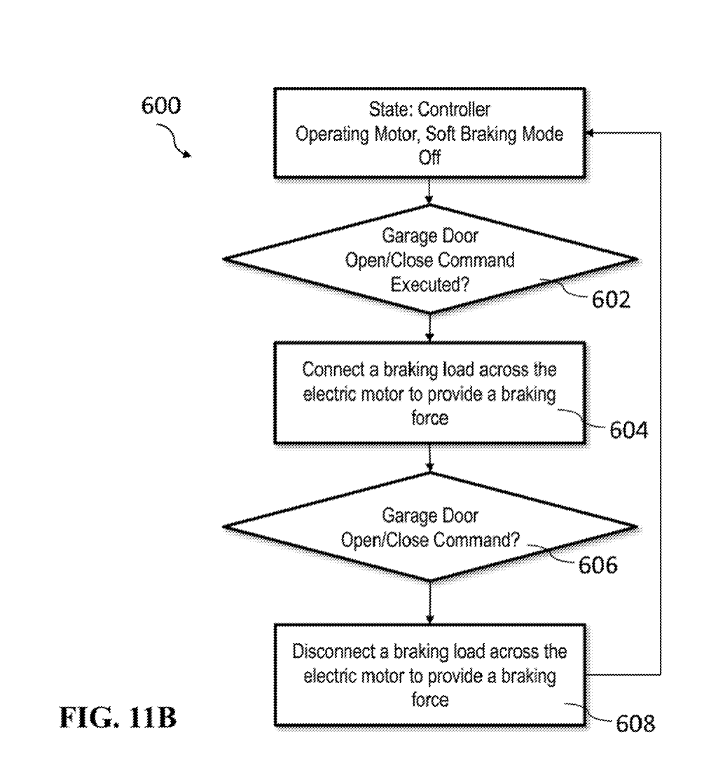

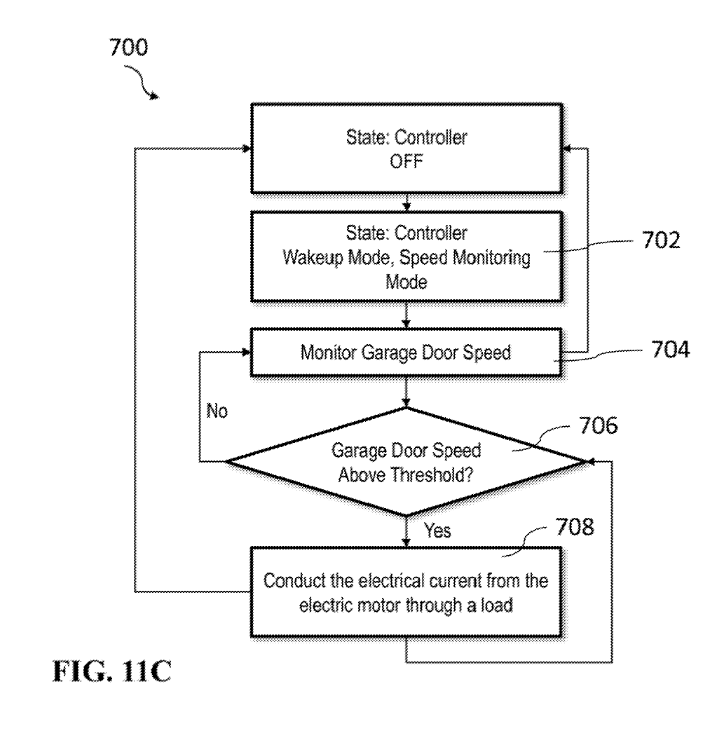

Now referring to FIGS. 11A to 11C, there are illustrated software flow diagrams representative of instructions stored in memory 43b executed by computing module 43a based on the state of the electronic control module 43 and the garage door 12. For example FIG. 11A illustrates a flow diagram executed by the electronic control module 42 when the electronic control module 42 is in the Controller Operating Motor, Soft Braking Mode Off State 401, and includes the electronic control module 42 determining if a manual control of garage door is detected 502. If the electronic control module 42 determines a manual control of garage door is detected 502, the electronic control module 42 deactivates the motor 504 and proceeds to monitor the garage door speed 506, such as by detecting the rotational speed of the motor 52, or door 12. Next, the electronic control module 42 determines if the garage door speed is above a speed threshold 508. If the electronic control module 42 determines the garage door speed is above a speed threshold, the electronic control module 42 determines to conduct the electrical current from the electric motor through a load 510, for example by controlling the brake circuit 100 as described hereinabove, and will return to the step of determining if the garage door speed is above a speed threshold 508.

For example, FIG. 11B illustrates a flow diagram executed by the electronic control module 42 when the electronic control module 42 is operating in the Controller Operating Motor, Soft Braking Mode Off State 401, and includes the electronic control module 42 determining if a Garage Door Open/Close Command has been Executed 602, for example determines if the garage door 12 has been moved from fully closed to a fully opened position. If the electronic control module 42 determines the Garage Door Open/Close Command has been executed, the electronic control module in response will connect a braking load across the electric motor 52 to provide a braking force 604, and for example operate first switch 108 in soft braking mode as described herein above. If the electronic control module 42 determines another subsequent Garage Door Open/Close Command has been received 606, the electronic control module 42 in response will disconnect a braking load across the electric motor to provide a braking force 608, and for example not operate first switch 108 in soft braking mode as described herein above. Electronic control module 42 will subsequently operate in the Controller Operating Motor, Soft Braking Mode Off State 401.

For example, FIG. 11C illustrates a flow diagram executed by the electronic control module 42 when the electronic control module 42 is operating the Controller OFF state 404. In response to electronic control module 42 transitioning 702 to the Controller Wakeup Mode and Speed Monitoring Mode 406, electronic control module 42 will monitor the garage door speed or motor 52 speed 704, and determine if the detected speed is above a threshold 706. If electronic control module 42 determines the detected speed is above a threshold, the electronic control module 42 will control the braking circuit 100 to conduct the electrical current from the electric motor 52 through a load, for example such as second braking resistor 120 in step 708. If the motor 52 speed decreases to a rate where the induced voltage is insufficient to power the electronic control module 42, the electronic control module 42 will transition to the Controller OFF state 404.

Obviously, many modifications and variations of the present invention are possible in light of the above teachings and may be practiced otherwise than as specifically described while within the scope of the appended claims.

What is claimed is:

1. A garage door opener comprising:
an electric motor coupled to a garage door via a mechanical linkage for raising and lowering the garage door; and
a motor drive controller configured to provide electrical power to the electric motor to cause the electric motor to apply a driving torque to the mechanical linkage for raising or lowering the garage door;
wherein said motor drive controller is operable in a braking mode to direct electrical current from the electric motor through a load to cause the electric motor to apply a braking force in opposition to an external force applied to the mechanical linkage.

2. The garage door opener of claim 1, wherein the electric motor generates an induced voltage in response to application of the external force to the mechanical linkage, said induced voltage used to supply electrical power to the motor drive controller.

3. The garage door opener of claim 1, further comprising a first switch operable by the motor drive controller in a soft braking mode to conduct electrical current from the electric motor through the load to cause the electric motor to apply a first braking force in opposition to an external force.

4. The garage door opener of claim 1, wherein the mechanical linkage includes a pulley and a cable.

5. The garage door opener of claim 3, wherein the load includes a first braking resistor.

6. The garage door opener of claim 3, further comprising:
a braking controller configured to monitor a speed of the electric motor and to selectively command a second switch to conduct the electrical current from the electric motor through a second braking resistor to cause the electric motor to apply a second braking force in opposition to the external force; and
wherein the second braking force is substantially larger than the first braking force.

7. The garage door opener of claim 6, wherein the load is configured to provide electrical power using an induced voltage generated by the electric motor in response to application of an external force to the mechanical linkage to operate the braking controller with the first switch in the braking mode.

8. The garage door opener of claim 6, wherein the motor drive controller includes the braking controller.

9. The garage door opener of claim 2, wherein the load includes a rectifier configured to provide a rectified power output from the electrical current from the electric motor, the rectified power output used to supply electrical power to the motor drive controller.

10. The garage door opener of claim 3, wherein the first switch is configured to be in the soft braking mode with at least one of the utility line power removed from the garage door opener and the motor drive controller in a power off state.

11. The garage door opener of claim 3, wherein the first switch is configured to be in the soft braking mode with the garage door opener in a manual mode with the motor drive controller prevented from supplying power to the electric motor; and
wherein the first switch is configured to be in a non-braking mode inhibiting electrical current from the electric motor from flowing through the load with the garage door opener in an automatic mode with the motor drive controller able to supply power to the electric motor.

12. A method for operating a garage door opener comprising:
actuating an electric motor of the garage door opener by an external force;
generating an induced voltage by the electric motor;
conducting electrical current through a load;
dissipating power by the load to cause the electric motor to apply a braking force in opposition to the external force.

13. The method for operating a garage door opener as set forth in claim 12, wherein electrical current is conducted through the load when at least one of the garage door opener is in a manual mode, and a speed of the electric motor exceeds a preset value.

14. The method for operating a garage door opener as set forth in claim 12, further comprising conducting electrical current through a first switch between the electric motor and the load with the first switch in a soft braking mode.

15. The method for operating a garage door opener as set forth in claim 14, further comprising:
supplying electrical power to the electric motor to cause the electric motor to drive a garage door between an opened and a closed position with the first switch in a non-braking mode; and
inhibiting electrical power from being supplied to the electric motor with the first switch in the soft braking mode.

16. The method for operating a garage door opener as set forth in claim 14, wherein the load includes a first braking resistor configured to dissipate power to cause the electric motor to apply a first braking force in opposition to the external force.

17. The method for operating a garage door opener as set forth in claim 12, further comprising: supplying electrical power to operate a braking controller using the induced voltage from the electric motor.

18. The method for operating a garage door opener as set forth in claim 16, further comprising:
conducting electrical current through a second switch between the electric motor and a second braking resistor with the second switch in a hard braking mode;
inhibiting flow of electrical current through the second switch between the electric motor and the second braking resistor with the second switch not in the hard braking mode; and
dissipating power by the second braking resistor to cause the electric motor to apply a second braking force in opposition to the external force.

19. The method for operating a garage door opener as set forth in claim 18, wherein the second braking force is substantially larger than the first braking force.

20. The method for operating a garage door opener as set forth in claim 18, further comprising:
monitoring a speed of the electric motor;
causing the second switch to be in the hard braking mode in response to the speed of the electric motor exceeding a preset value; and
slowing the garage door by the electric motor applying the second braking force.
